(19) United States
(12) Patent Application Publication
(10) Pub. No.: US 2003/0135422 A1
(43) Pub. Date: Jul. 17, 2003

(54) Marketing and e-commerce tool and method for channel partners

(76) Inventor: Kristi Cordova, Rocklin, CA (US)

Correspondence Address: HEWLETT-PACKARD COMPANY, Intellectual Property Administration, P.O. Box 272400, Fort Collins, CO, 80527-2400, US

(21) Appl. No.: 10/050,290

(22) Filed: Jan. 16, 2002

(51) Int. Cl. G06F 17/60

(52) U.S. Cl. 705/26

(57) ABSTRACT

A system that comprises at least one reseller's electronic site wherein each such site is arranged to display information pertaining to products selectable by an accessing user and wherein products that are provided to the reseller are provided from a source independent from said reseller. The system includes at least one database controlled by the independent source, wherein that database is arranged to contain information specific to the source's products that are displayable to the user via the reseller's electronic site and at least one communication link that is controlled jointly by the source and the reseller and that is responsive to a request for updated data so as to provide the latest version of the requested data to a database controlled by the reseller.

### BACKGROUND OF THE INVENTION

A manufacturer, or wholesaler, typically sells its products, parts and services to the public through resellers. Such resellers typically have electronic presentation capability, usually via the Internet or World Wide Web (WEB). This presentation capability may be available to the consumer at a physical location, such as at a retail store site, or may be available directly to the consumer via an Internet or WEB browser from the consumer's private computer.

The consumer, taking advantage of the reseller's electronic presentation capability, may log onto the reseller's WEB site or onto any other electronic location available from the reseller and, once logged-on, may browse displays of the manufacturer's products, services, parts, specifications and the like. Usually, such electronic presentation sites contain products and services from many different suppliers, and a user may find the desired goods or services (for example, which have been produced by a specific manufacturing service) displayed on a number of different Internet or WEB sites. The arrangement of the display at a particular site, and even the information that is available to the customer from that site, is controlled by the designer and/or manager of the Internet or WEB site and thus will vary from one reseller site to another, even with respect to goods or services of the same manufacturer. Accordingly, it is a problem that the available information is not displayed in a standardized way.

An further problem is that, as manufacturers change their products, updated information must then be disseminated to many different resellers, each of whom must then update their own individual Internet or WEB sites. The timing of such reseller updates is out of the control of the manufacturer and, thus, the situation arises that there is a lack of consistency in the information that is available regarding the manufacturer's products and services as a customer accesses different reseller sites.

This lack of consistency exists, not only for individual products and services, but also exists as to the manner in which a manufacturer's products are displayed to the public. Thus, manufacturers who desire to have their products and services displayed consistently from location to location have a difficult time achieving that goal.

Another problem arises when it is desired to allow customers to see not only the content of a particular product, but to also try a current product, such as a software product, prior to the purchase of that product. This capability presents problems for certain types of products, such as software products, where manufacturers typically do not want the software to be available to the public because it could be improperly used or misappropriated. Thus, when a potential customer accesses an Internet or WEB site of a reseller and wishes to have a demonstration copy of a software program, the demonstration copy is provided, if at all, directly from the manufacturer under manufacturer's control and is not provided by the reseller. This presents logistical and other problems due to the fact that the various product versions that are shown on different reseller sites may be coordinated with the central source of the product. Of course, this same problem occurs when the information that a potential customer sees on a reseller site relates to an older version of the product that has been updated or replaced by the manufacturer. If the customer desires in-depth information about a product displayed on an Internet or WEB site, the actual product that is currently supported by the manufacturer may have changed.

Currently, these types of problems are solved by the establishment of links from the reseller's site to the wholesaler's (or manufacturer's) site such that when additional information is desired, the customer is transferred to the wholesaler's (or manufacturer's) site. This effectively causes the sales relationship with the potential customer to move from the reseller to the wholesaler, which is confusing and disruptive to the orderly flow of commerce.

### BRIEF SUMMARY OF THE INVENTION

A system that comprises at least one reseller's electronic site, such as an Internet or World Wide Web site, wherein each such site is arranged to display information pertaining to products selectable by a user who accesses the electronic site, and wherein products that are provided to the reseller are provided from a source independent from said reseller.

The system includes at least one database that is controlled by the independent source, wherein that database is arranged to contain information specific to the source's products that may be displayed to the user via the reseller's electronic site. The system also includes at least one communication link that is controlled jointly by the source and the reseller and that is responsive to a request for updated data for accessing the database so as to provide the latest version of the requested data to a database controlled by the reseller.

### BRIEF DESCRIPTION OF THE DRAWINGS

FIG. 1 is a block diagram of one embodiment of the invention; and

FIG. 2 through FIG. 6 are flowcharts of various system operations of one embodiment of the invention.

### DETAILED DESCRIPTION OF THE INVENTION

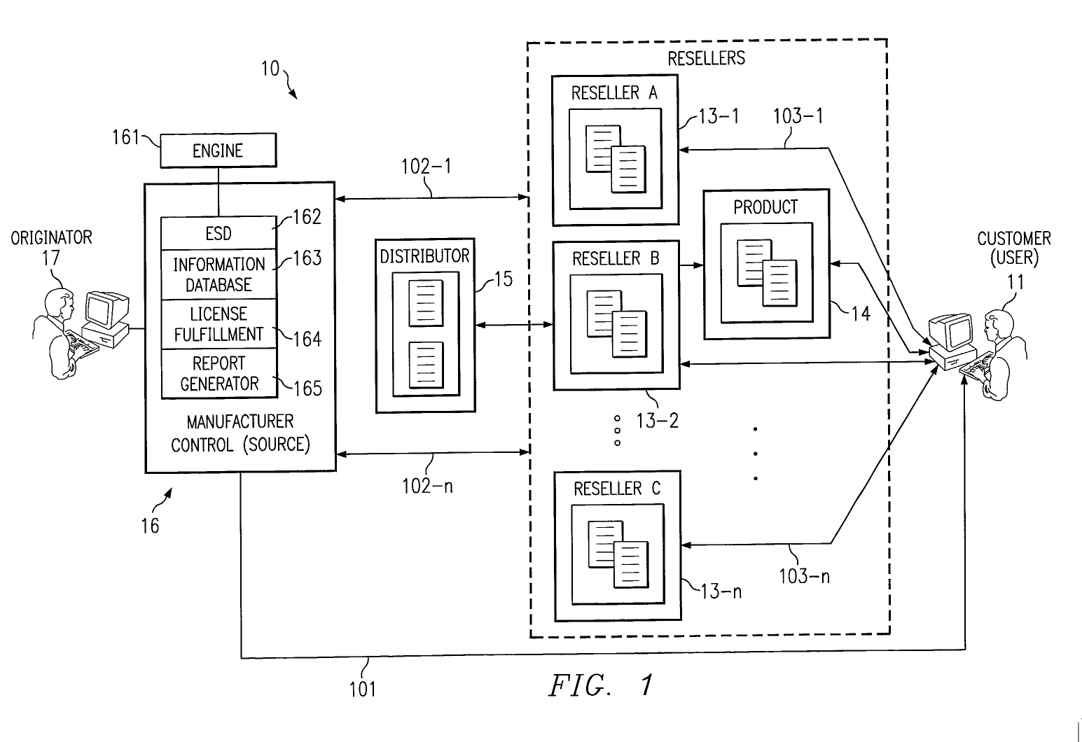

Turning now to FIG. 1, there is shown system 10 that includes a plurality of individual reseller electronic sites 13-1 to 13-n, each site accessible by users, such as user 11. A user may search several such sites via link 103-1 to 103-n in an attempt to deal with a reseller known to that user or in order to find a reseller with lowest prices, better service or a larger selection of goods. Once the user selects a particular site, for example, site 13-2 in FIG. 1, the user may select a particular product, such as product 14.

At some point, reseller 13-2 will typically ask user 11 for his/her identity (which could include name, password, e-mail address and any other desired information). This will establish a commercial relationship between user 11 and reseller 13-2, which will allow user 11 to purchase products or services or, as will be seen, allow user 11 to obtain additional product information or even obtain a demonstration of the product. As discussed above, it is important to deliver latest product information to the user. It is also important to provide the same information to all users regardless of which reseller site 13-n the user has selected to browse.

Continuing now in FIG. 1, manufacturer control 16 is shown with data originator 17, who may, of course, actually represent multiple people or multiple systems. Data originator 17 may be locally or remotely situated (not shown) and is preferably connected to manufacturer control 16, which may also be comprised of multiple systems located either in close physical proximity or spread out geographically.

Engine 161, which could, by way of example, be an HP-UX running on an HP K-Class Unix Server, is used to control the system that consists of Electronic Software Download (ESD) 162; information database 163 and, if desired, license fulfillment 164. The software could be, if desired, Java Applets. Note, as will be discussed, that the system described herein can be used for e-commerce transactions as well as for the direct downloading of software products, including music, video, games, languages and the like, and/or samples and demonstrations thereof. Information database 163 houses the content and product information that will be displayed to users via reseller sites. The information database 163 (or a separate database) will also house additional information available upon request for a specific user. The actual product, such as a software product, can be delivered to the customer directly from this database, even though the user pays the reseller directly for the product. If desired, there could be one or more distributors 15 interposed between the manufacturer and the reseller. Each reseller electronic site can be controlled using different services and even different languages, but, for purposes of discussion herein, it will be assumed that all resellers use a common language and programming structure, such as, for example, JAVA and HTML. If in practice this is not the situation, the appropriate provisions will have to be made, either at manufacturer control 16 or at the individual reseller sites, for proper conversion.

As will be discussed, the individual reseller locations may be set up with electronic sites that can be populated via links, for example API or PD/API links, from manufacturer control (source) 16. From time to time, as will be discussed, the data from source 16 is transmitted to each reseller site via an API or PD/API link so that all of the reseller sites display the same information, in the same format, to a user. The information from source 16 is then maintained in a database controlled by the reseller.

In operation, when user 11 selects product 14 and desires more information about product 14, the user makes a request to reseller 13-2 for the information. Reseller 13-2, in turn, sends the request to site 16 (or another site depending upon the request), together with the e-mail address of user 11. The request will be made via links 102-1 to 102-n. Source 16 then can e-mail the desired information directly to user 11 as will be detailed hereinafter. The e-mailed information can, for example, be specific product specifications, uses, restrictions, dimensions, power requirements, and the link, or the information may be a demonstration version of a software program.

When the user decides to purchase the product, the actual purchase transaction occurs between user 11 and site 13-2 and not between user 11 and site 16. The actual delivery of the product can be provided, either electronically or physically, directly from the manufacturer, but the shipping information (whether electronic or physical) can, if desired, show that it came from the selected reseller so as to maintain a commercial relationship between the reseller and the buying user.

Source 16 keeps control of the information it sends to user 11 via the e-mail link, thereby maintaining security and ensuring that the latest product is sent to the user at all times. When a distributor, such as distributor 15, is in the commercial channel, the reseller will replenish its stock (or pay a portion of what it has collected from user 11) to the distributor, who, in turn, pays the manufacturer.

The system may track the number of customers that come from a particular reseller on report generator 165 (FIG. 1). Using this option, there would be created a list of the reseller's customers who purchased each product. This list will be used to control payment from the reseller to the manufacturer, and is used to place orders in the normal ordering systems. The difference being that the order is placed in a “Do Not Ship” fashion (since it has been delivered to the customer directly) so that it is a non-shippable order. This allows all the commissions to be paid properly even though nothing is shipped from the reseller.

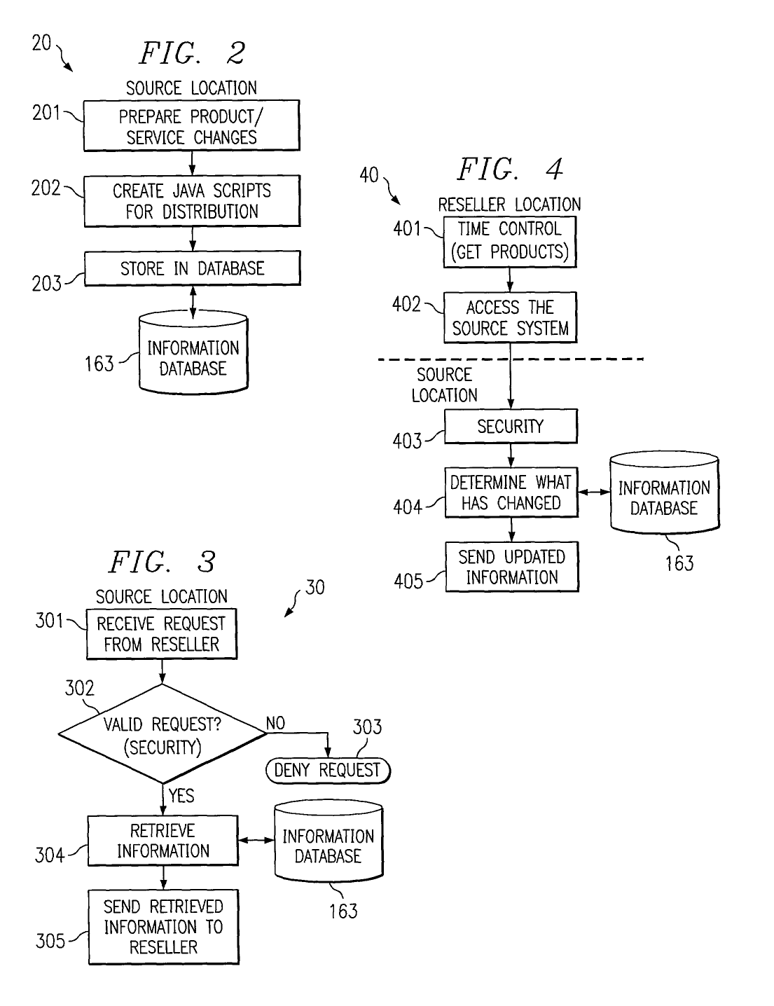

Turning now to FIG. 2, there is shown an illustrative flowchart 20, operational at the source location, where an originator, such as originator 17 (FIG. 1) prepares information pertaining to a new product, or prepares changes to an existing product or service, as shown in box 201. When those changes are finished, the system that is used by the originator creates scripts, such as Java scripts, for distribution to the various resellers via box 202. When these distribution scripts have been completed, they are sent to database 163 (FIG. 1) via storage mechanism 203. It should be noted that storage database 163 can be a single database or a multiplicity of databases, and can be arranged in any one or more of the well known fashions, such that the information in the database can replace information previously established for a particular product. The new and/or updated information may, if desired, reside in conjunction with the previous information, so that a history can be maintained, so that different resellers could, if desired, access different versions of the information for the same product. This would be at the discretion of the originator, or if desired, at the discretion of the reseller and may be used, for example, if different levels of resellers are employed.

FIG. 3 again shows the source location in flowchart 30 receiving a request from a reseller via box 301. The source location, via control 302, checks the validity of the request and performs whatever security is desired to insure that a proper reseller has accessed the system. If this security check is not properly completed, then step 303 will deny the request. However, if the request is a valid request, then the request is passed to retrieve information box 304, which then goes to database 163 (FIG. 1) to retrieve the latest information for the specific product in accordance with the request received from the reseller. Box 305 then sends the retrieved information to the reseller at the reseller's location.

The information that is sent via the API or PD/API links populates the actual pages at the reseller's location, such that when a user, for example user 11 in FIG. 1, accesses the retailer's electronic site, the electronic page is brought up at the retailer's site under control of the reseller's server, and shows the latest information that has been downloaded from the source location via control 305. Thus, the user, by accessing any retailer site, will receive the same visual information that he or she would have received if the access had been made to a different reseller site.

In FIG. 4, flowchart 40 shows the reseller location where the program is set up via control 401 to obtain the latest product information. This could be under time control, or it could be a time of day control, or it can be an interval controller such that after a certain interval has passed, the ‘get product’ request is launched. Or, if desired, control 401 could be under manual control of the reseller. Once the ‘get product’ command is launched, box 402 accesses the source system by sending a message over an API link, or any other message link, such as an email message to the source location, which then, via security control 403 and control 404, accesses database 163 to determine what has changed since the last request. The updated information is then sent via box 405 to the requesting reseller site. It should be noted that the control for determining what has changed is now well known in the art and can be any one of a number of different programs. One such system can be, by way of example, the “Get Products” command facilitated by PDAPI which then would automatically update the reseller site with new information/

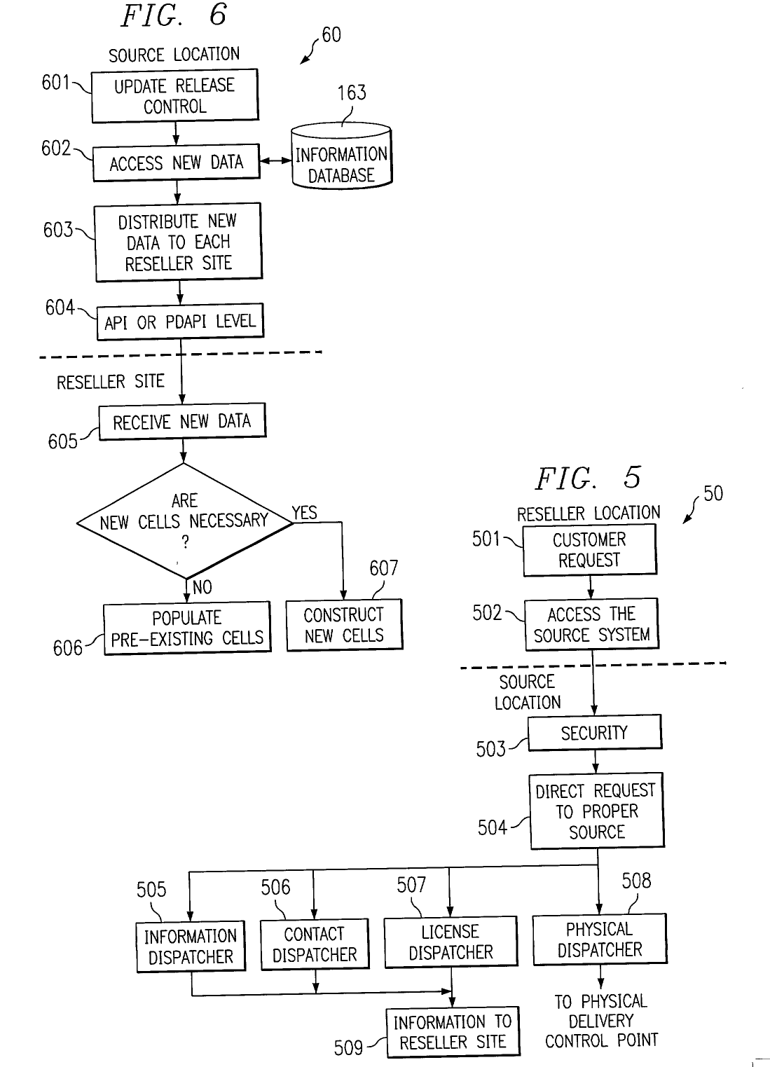

FIG. 5 shows flowchart 50, which represents actions that are initiated at a reseller location. A customer request is received via box 501. This request could be, for example, a user who is logged onto the reseller's website, deciding on a particular product and identifying the product through an interactive exchange with the reseller's site, and wants to obtain a specification, i.e., height, weight, or any other information desired on a product which would not normally be presented from the reseller's site. This request could also, of course, be a desire for a demonstration copy, or in fact, a purchase of a software package. In any event, the request from the customer triggers box 502, which in turn accesses the source system via API or PD/API links or via email or any other mechanism. When the request is received at the source location, the system causes security to be verified as discussed above via box 503, and then the request is directed to the proper information source via box 504. The source could be information dispatcher 505, content dispatcher 506, license dispatcher 507, or perhaps physical dispatcher 508 or the like. Physical dispatcher 508 would be arranged to send a physical product to the end user directly via a mail or courier service. Information dispatcher 505 would operate to provide information pertaining to the product such as weight, height, number of bits, or other desired information. Content dispatcher 506, on the other hand, would operate to provide at least a portion of the actual content if the requested product were, for example, an application program. The information is sent to the reseller site via system 509.

The method of transmission from the source location to the user can be, for example, via an email link, such as link 101 (FIG. 1), using email information that was provided from the reseller to the source via box 502 during initial request for the data. The system at this time could, if desired, provide a copy of a license via box 507 to the end user, and request an acknowledgement of some type such as return email, or the operation of a particular key, which could be delivered either directly back to the source via the e-mail link or over the link from the user to the source. This acknowledgment could, if desired, go from the user to the screen provided by the reseller, which then would be transmitted from the reseller site to the source site. Of course, the information from source 16 (FIG. 1) could be passed to user 11 via the reseller's site if desired.

FIG. 6 shows flowchart 60 at the source location, and illustrates one method of achieving the update at all of the reseller sites. In this illustrative illustration, update release control 601 determines that it is time to update the reseller sites, and accesses database 163 to find the new data via box 602 in a manner discussed above. This new data is distributed, via box 603, to each reseller site over the API or DP/API link as shown by 604, again as discussed above. This information is then sent to the reseller's site and is received via box 605. A determination is then made, either from the data sent or from a separate communication from the source telling the sites whether or not one or more new electronic sites or pages are necessary. If they are not necessary, then the data which is received over the API or PD/API link is used to populate the pre-existing electronic sites or pages via box 606 at the reseller's site.

However, if new pages or electronic sites are required, they are constructed either automatically via box 607, or by a programmer at the reseller's site who would then establish the necessary links and sites and/or pages for subsequent population from data transmitted from the source to the reseller's site.

Report generator 165 at source 11 (FIG. 1) also lists data pertaining to various users, such as, for example, which customers have tried a product and not bought that product; how many times a user accesses the system; and number of products (by type) purchased by a user or group of users. The system then may generate a list of leads or other statistical data to provide to resellers so that they can follow up with their potential customers or provide follow-on services or products, if desired. In the preferred embodiment, this statistical data would be maintained on a reseller by reseller basis, thus maintaining proper commercial relationships.

One of the benefits of the system described herein is that it facilitates both e-commerce transactions and trial software downloads through reseller storefronts. Using this system, resellers also need not stock and send CDs to customers through the mail. Also, resellers do not need to keep their websites up-to-date themselves since the distributor/manufacturer will send any new product or promotional information through the PD/API pipeline for automatic updating of the reseller site.

What is claimed is:

1. A system comprising:
at least one reseller's electronic site, each such site arranged to display information pertaining to products that are selectable by a user, said products provided to said reseller from a source independent from said reseller;
at least one database controlled by said independent source, said database arranged to contain information specific to said source's products that are displayable to said user via said reseller's electronic site; and
at least one communication link controlled jointly by said source and said reseller, the link responsive to a request for updated data and for accessing said database to provide the latest version of the requested data to a database controlled by said reseller.

2. The system of claim 1 wherein said source-controlled database can communicate to a plurality of databases, each controlled by a different reseller.

3. The system of claim 1 further comprising means for causing the distribution of product data to a plurality of reseller's electronic sites, such that the product data will be uniformly displayed to an accessing user regardless of which one of said plurality of reseller's electronic sites said user accesses.

4. The system of clam 1 further comprising:
at least one second communication link established from said source database to an accessing user at a reseller's electronic site such that said accessing user may receive certain data directly from said source database while said accessing user remains in communication with said reseller's electronic site, said second communication link independent from said first-mentioned communication link.

5. The system of claim 1 further including:
means at said reseller's electronic site for receiving provided versions of the requested data and for using said provided data to directly populate already established electronic pages at said reseller's electronic site.

6. The system of claim 1 wherein said communication links extend to a plurality of reseller sites.

7. The system of claim 6 wherein each of said plurality of reseller sites includes:
means for using data provided over said communication links from said source database to directly populate already existing electronic pages such that the data that is provided from said source database is uniformly displayed to a user regardless of which of said reseller's electronic sites said user accesses.

8. A method for updating a plurality of reseller electronic sites from a source location; said method comprising the steps of:
updating a database at said source location with information pertaining to a plurality of products; and
delivering, from time to time, said updated information from said database to said reseller sites; and
using, at each said reseller site, the data as delivered from said source to directly populate electronic pages established on said reseller's electronic site.

9. The method of claim 8 wherein the time of delivery of said delivery step is controlled by a requesting reseller electronic site.

10. The method of claim 8 wherein said directly populating step is operable to establish uniformity at all said reseller electronic sites.

11. The method of claim 8 further including the steps at said reseller site of:
(a) establishing a transactional relationship between a user and said reseller;
(b) receiving from said user a specific request; and
(c) communicating said user's request to said source; and
said method further including the steps at said source of:
(a) receiving user requests from said resellers; and
(b) directly fulfilling each said request from said source to said user while still maintaining said established transactional relationship.

12. The method of claim 11 wherein said direct fulfillment includes the step of:
providing one of specification sheets, content, physical delivery; and
wherein said maintained transactional relationship controls of payment between said user and said reseller.

13. The method of claim 11 wherein said system maintains the traditional channel relationships between said source, said reseller and said users.

14. The method of claim 11 wherein said source location provides leads to said reseller based on received ones of said user requests.

15. A system comprising:
at least one reseller's electronic site, each such site arranged to display to an accessing user at said reseller's electronic site information pertaining to products selectable by said accessing user, said products provided to said reseller from a source independent from said reseller;
at least one database controlled by said source, said database arranged to contain information specific to said source's products that are displayable to said accessing user via said reseller's electronic site; and
a communications link controlled at least in part by said reseller and responsive to a request for certain information from said accessing user for accessing said database to provide the latest version of said requested information directly from said database to said accessing user while still maintaining an active electronic communication link between said accessing user and said reseller.

16. The system of claim 15 wherein said certain information is an electronic version of a user specified product, said product being specified in a transaction between said user and said reseller.

17. The system of claim 15 further including:
communication links controlled at least in part by a plurality of resellers and responsive to a request for certain information from an accessing user at any of said resellers for providing said accessing user with requested data while still maintaining the connection from said user to the reseller selected by said user.

18. A method for controlling data presentation to users who access a selected one of a plurality of reseller electronic sites; said method comprising the steps of:
maintaining a source location database with information pertaining to a plurality of products; and
from time to time, on request of a particular one of said reseller sites, delivering a requested portion of said information from said database to an identified user then connected electronically to said reseller's electronic site, said information delivered over a link identified by said reseller at a time when said user remains connected to said reseller's site.

19. The method of claim 18 further including the steps of:
accepting a purchase order for a user selected product under control of said source location;
controlling the delivery of said product to said user by said source location; and
concurrently while said order is being accepted by said source location maintaining a commercial relationship between said user and the reseller to which said user is then electronically connected.

20. The method of claim 19 further comprising the step of providing statistical data for each said reseller pertaining only to users who were serviced by said source location under control of said reseller.
